(19) United States
(12) Patent Application Publication
(10) Pub. No.: US 2024/0088982 A1
(43) Pub. Date: Mar. 14, 2024

(54) METHODS, SYSTEMS, AND DEVICES FOR PERFORMING A REGULARLY CODED BEAM SWEEP FOR SPATIAL CHANNEL SOUNDING

(71) Applicant: ZTE CORPORATION, Shenzhen (CN)

(72) Inventor: Ning WEI, Shenzhen (CN)

(73) Assignee: ZTE CORPORATION, Shenzhen (CN)

(21) Appl. No.: 18/380,363

(22) Filed: Oct. 16, 2023

Related U.S. Application Data
(63) Continuation of application No. PCT/CN2021/088278, filed on Apr. 20, 2021.

(51) Int. Cl. H04B 7/06

(52) U.S. Cl. CPC H04B 7/0696

(57) ABSTRACT

The present disclosure relates to methods, systems, and devices for performing a regularly coded beam sweep for spatial channel sounding. In one form, a method for wireless communication includes: accessing, at a transmitter, a regular codebook configured to utilize multiple beams on a resource unit as part of a coded beam sweep for spatial channel sounding; transmitting, from the transmitter to a receiver, a steering sound signal utilizing a beam codeword of the regular codebook that identifies multiple beams for transmission on the resource unit; and receiving, at the transmitter, channel state information from the receiver, the channel state information determined at the receiver based on a strength of the steering sound signal when received at the receiver over the multiple beams identified in the beam codeword.

### TECHNICAL FIELD

This document is directed generally to wireless communications.

### BACKGROUND

Within wireless communication systems, a performance of proposed exhaustive beam sweeps for spatial channel sounding is heavily constrained by two common negative factors often seen in communication systems: side-lobe leakage of beam and noise interference. Further, traditional single-beam sweeping algorithms are becoming more and more unfavorable for narrow-band beam mode in massive multiple-input multiple-output (MIMO) systems due to a rapid growth of time complexity. Accordingly, it is desirable to develop new methods that provide the ability to simultaneously reduce time complexity and improve beam detection accuracy of channel sounding procedures based on imperfect measurements.

### SUMMARY

This document relates to methods, systems, and devices for performing a regularly coded beam sweep for spatial channel sounding.

In some implementations a method for wireless communication includes: accessing, at a transmitter, a regular codebook configured to utilize multiple beams on a resource unit as part of a coded beam sweep for spatial channel sounding; transmitting, from the transmitter to a receiver, a steering sound signal utilizing a beam codeword of the regular codebook that identifies multiple beams for transmission on the resource unit; and receiving, at the transmitter, channel state information from the receiver, the channel state information determined at the receiver based on a strength of the steering sound signal when received at the receiver over the multiple beams identified in the beam codeword.

In some other implementations, a wireless communication apparatus comprises a processor and a memory, wherein the processor is configured to read code from the memory and implement a method as recited above.

In yet other implementations, a computer program product comprises a computer-readable program medium code stored thereupon, the code, when executed by a processor, causing the processor to implement a method as recited above.

In some other implementations, a method for wireless communication includes: accessing, at a receiver, a regular codebook configured to utilize multiple beams on a resource unit as part of a coded beam sweep for spatial channel sounding; receiving, at the receiver, a steering sound signal that was transmitted utilizing a beam codeword of the regular codebook that identifies multiple beams for transmission on the resource unit; measuring, at the receiver, a strength of the steering sound signal when received over the multiple beams identified in the beam codeword; calculating channel state information, at the receiver, based on the measured strength of the steering sound signal; and transmitting the channel state information from the receiver to the transmitter.

In some other implementations, a wireless communication apparatus comprises a processor and a memory, wherein the processor is configured to read code from the memory and implement a method as recited above.

In yet other implementations, a computer program product comprises a computer-readable program medium code stored thereupon, the code, when executed by a processor, causing the processor to implement a method as recited above.

The above and other aspects and their implementations are described in greater detail in the drawings, the descriptions, and the claims.

### BRIEF DESCRIPTION OF THE DRAWINGS

FIG. 1 shows an example of a wireless communication system.

FIG. 2 shows example layers of a communication node of the wireless communication system of FIG. 1.

FIG. 3 is a flow chart of one form of a method for performing a regularly coded beam sweep for spatial channel sounding.

FIG. 4 is an example resource block with a plurality of resource units

FIG. 5 is an example sparsity codebook.

FIG. 6 is another example sparsity codebook.

FIG. 7 illustrates a channel sounding procedure where a receiver utilizes an omnidirectional beam.

FIG. 8a illustrates a channel sounding procedure where a receiver utilizes a coded beam and prolonged transmission time intervals.

FIG. 8b illustrates a channel sounding procedure where a receiver utilizes a coded beam and consecutive transmission time intervals.

FIG. 8c illustrates a channel sounding procedure where a receiver utilizes a coded beam and discrete transmission time intervals.

FIG. 9a illustrates one form of a coding diagram.

FIG. 9b is a convolution codebook associated with the coding diagram of FIG. 9a.

FIG. 10a illustrates one form of a coding diagram.

FIG. 10b is a convolution codebook associated with the coding diagram of FIG. 10a.

### DETAILED DESCRIPTION

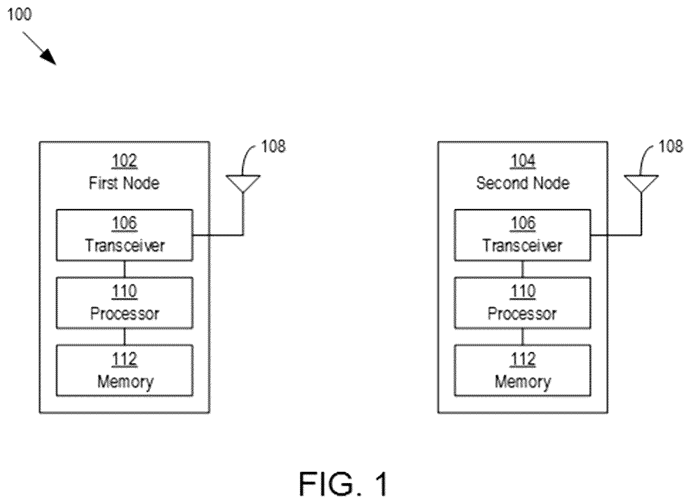

The present disclosure relates to methods, systems, and devices for performing a regularly coded beam sweep for spatial channel sounding. FIG. 1 shows a diagram of an example wireless communication system 100 where a regularly coded beam sweep for spatial channel sounding may be implemented. In one form, the wireless communication system 100 includes a plurality of communication nodes that are configured to wirelessly communicate with each other. The communication nodes include a first node 102 and a second node 104. Various other examples of the wireless communication system 100 may include more than two communication nodes.

In general, each communication node is an electronic device, or a plurality (or network or combination) of electronic devices, that is configured to wirelessly communicate with another node in the wireless communication system, including wirelessly transmitting and receiving signals. In various implementations, each communication node may be one of a plurality of types of communication nodes.

One type of communication node is a user device. A user device may include a single electronic device or apparatus, or multiple (e.g., a network of) electronic devices or apparatuses, capable of communicating wirelessly over a network. A user device may include or otherwise be referred to as a user terminal or a user equipment (UE). Additionally, a user device may be or include, but not limited to, a mobile device (such as a mobile phone, a smart phone, a tablet, or a laptop computer, as non-limiting examples) or a fixed or stationary device, (such as a desktop computer or other computing devices that are not ordinarily moved for long periods of time, such as appliances, other relatively heavy devices including Internet of things (IoT), or computing devices used in commercial or industrial environments, as non-limiting examples).

A second type of communication node is a wireless access node. A wireless access node may comprise one or more base stations or other wireless network access points capable of communicating wirelessly over a network with one or more user devices and/or with one or more other wireless access nodes. For example, the wireless access node 104 may comprise a 4G LTE base station, a 5G NR base station, a 5G central-unit base station, a 5G distributed-unit base station, a next generation Node B (gNB), an enhanced Node B (eNB), or other base station, or network in various embodiments.

As shown in FIG. 1, each communication node 102, 104 may include transceiver circuitry 106 coupled to an antenna 108 to effect wireless communication. The transceiver circuitry 106 may also be coupled to a processor 110, which may also be coupled to a memory 112 or other storage device. The processor 110 may be configured in hardware (e.g., digital logic circuitry, field programmable gate arrays (FPGA), application specific integrated circuits (ASIC), or the like), and/or a combination of hardware and software (e.g., hardware circuitry (such as a central processing unit (CPU)) configured to execute computer code in the form of software and/or firmware to carry out functions). The memory 112, which may be in the form of volatile memory, non-volatile memory, combinations thereof, or other types of memory, may be implemented in hardware, and may store therein instructions or code that, when read and executed by the processor 110, cause the processor 110 to implement various functions and/or methods described herein. Also, in various implementations, the antenna 108 may include a plurality of antenna elements that may each have an associated phase and/or amplitude that can be controlled and/or adjusted, such as by the processor 110. Through this control, a communication node may be configured to have transmit-side directivity and/or receive-side directivity, in that the processor 110, and/or the transceiver circuitry 106, can perform beam forming by selecting a beam from among a plurality of possible beams, and transmit or receive a signal with the antenna radiating the selected beam.

Additionally, in various implementations, the communication nodes 102, 104 may be configured to wirelessly communicate with each other in or over a mobile network and/or a wireless access network according to one or more standards and/or specifications. In general, the standards and/or specifications may define the rules or procedures under which communication nodes 102, 104 can wirelessly communicate, which may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

In the wireless system 100, the communication nodes 102, 104 are configured to wirelessly communicate signals between each other. In general, a communication in the wireless system 100 between two communication nodes can be or include a transmission or a reception, and is generally both simultaneously, depending on the perspective of a particular node in the communication. For example, for a communication between the first node 102 and the second node 104, where the first node 102 is transmitting a signal to the second node 104 and the second node 104 is receiving the signal from the first node 102, the communication may be considered a transmission for the first node 102 and a reception for the second node 104. Similarly, where the second node 104 is transmitting a signal to the first node 102 and the first node 102 is receiving the signal from the second node 102, the communication may be considered a transmission for the second node 104 and a reception for the first node 102. Accordingly, depending on the type of communication and the perspective of a particular node, when a first node is communicating a signal with a second node, the node is either transmitting the signal or receiving the signal. Hereafter, for simplicity, communications between two nodes are generally referred to as transmissions.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, particular signals can be characterized or defined as either an uplink (UL) signal or a downlink (DL) signal. An uplink signal is a signal transmitted from a user device to the wireless access node. A downlink signal is a signal transmitted from a wireless access node to a user device. Also, certain signals may defined or characterized by combinations of data/control and uplink/downlink, including uplink control signals, uplink data signals, downlink control signals, and downlink data signals.

For at least some specifications, such as 5G NR, an uplink control signal is also referred to as a physical uplink control channel (PUCCH), an uplink data signal is also referred to as a physical uplink shared channel (PUSCH), a downlink control signal is also referred to as a physical downlink control channel (PDCCH), and a downlink data signal is also referred to as a physical downlink shared channel (PDSCH).

Also, some signals communicated in the system 100 may be defined or characterized as reference signals (RS). In general, a reference signal may be recognized in the system 100 as a signal other than a shared channel signal or a control signal, although a reference signal may be an uplink reference signal or a downlink reference signal. Non-limiting examples of reference signals used herein, and as defined at least in 5G NR, include a demodulation reference signal (DM-RS), a channel-state information reference signal (CSI-RS), and a sounding reference signal (SRS). A DM-RS is used for channel estimation to allow for coherent demodulation. For example, a DMRS for a PUSCH transmission allows a wireless access node to coherently demodulate the uplink shared channel signal. A CSI-RS is a downlink reference signal used by a user device to acquire downlink channel state information (CSI). A SRS is an uplink reference signal transmitted by a user device and used by a wireless access node for uplink channel-state estimation.

Additionally, a signal may have an associated resource that, in general, provides or identifies time and/or frequency characteristics for transmission of the signal. An example time characteristic is a temporal positioning of a smaller time unit over which the signal spans, or that the signal occupies, within a larger time unit. In certain transmission schemes, such as orthogonal frequency-division multiplexing (OFDM), a time unit can be a sub-symbol (e.g., a OFDM sub-symbol), a symbol (e.g., a OFDM symbol), a slot, a sub-frame, a frame, or a transmission occasion. An example frequency characteristic is a frequency band or a sub-carrier in or over which the signal is carried. Accordingly, as an example illustration, for a signal spanning N symbols, a resource for the signal may identify a positioning of the N symbols within a larger time unit (such as a slot) and a subcarrier in or over which the signal is carried.

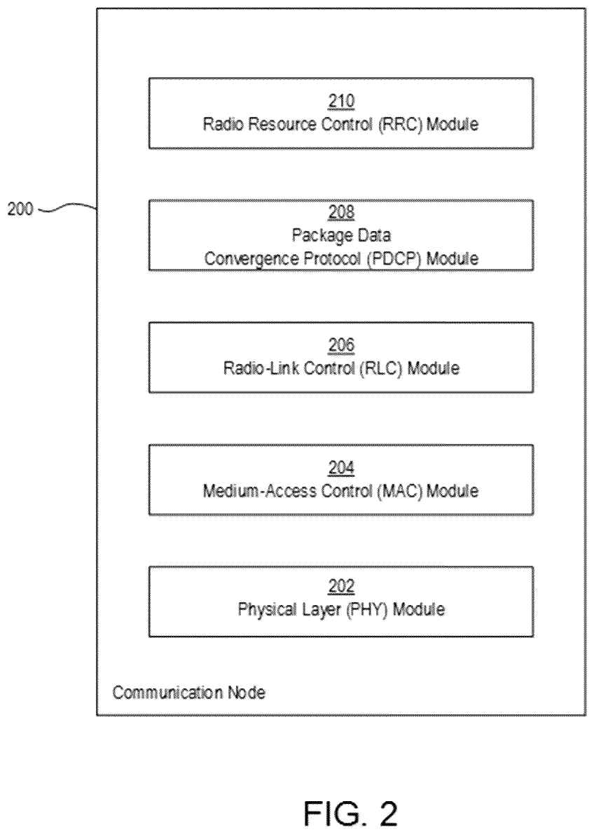

FIG. 2 shows a block diagram of a plurality of modules of a communication node 200, including a physical layer (PHY) module 202, a medium-access control (MAC) module 204, a radio-a link control (RLC) module 206, a package data convergence protocol (PDCP) module 208, and a radio resource control (RRC) module 210. In general, as used herein, a module is an electronic device, such as electronic circuit, that includes hardware or a combination of hardware and software. In various implementations, a module may be considered part of, or a component of, or implemented using one or more of the components of a communication node of FIG. 1, including a processor 110, a memory 112, a transceiver circuit 106, or the antenna 108. For example, the processor 110, such as when executing computer code stored in the memory 112, may perform the functions of a module. Additionally, in various implementations, the functions that a module performs may be defined by one or more standards or protocols, such as 5G NR for example. In various embodiments, the PHY module 202, the MAC module 204, the RLC module 206, the PDCP module 208, and RRC module 210 may be, or the functions that they perform may be, part of a plurality of protocol layers (or just layers) into which various functions of the communication node are organized and/or defined. Also, in various embodiments, among the five modules 202-210 in FIG. 2, the PHY module 202 may be or correspond to the lowest layer, the MAC module 204 may be or correspond to the second-lowest layer (higher than the PHY module 202), the RLC module 206 may be or correspond to the third lowest layer (higher than the PHY module 202 and the MAC module 204), the PDCP module 208 may be or correspond to the fourth-lowest layer (higher than the PHY module 202, the MAC module 204, and the RLC module 206), and the RRC module 210 may be or correspond to the fifth lowest layer (higher than the PHY module, the MAC module 204, the RLC module 206, and the PDCP module 208). Various other implementations may include more or fewer than the five modules 202-210 shown in FIG. 2, and/or modules and/or protocol layers other than those shown in FIG. 2.

The modules of a communication node shown in FIG. 2 may be perform various functions and communicate with each other, such as by communicating signals or messages between each other, in order for the communication node to send and receive signals. The PHY layer module 202 may perform various functions related to encoding, decoding, modulation, demodulation, multi-antenna mapping, as well as other functions typically performed by a physical layer.

The MAC module 204 may perform or handle logical-channel multiplexing and demultiplexing, hybrid automatic repeat request (HARD) retransmissions, and scheduling-related functions, including the assignment of uplink and downlink resources in both the frequency domain and the time domain. Additionally, the MAC module 204 may determine transport formats specifying how a transport block is to be transmitted. A transport format may specify a transport-block size, a coding and modulation mode, and antenna mapping. By varying the parameters of the transport format, the MAC module 204 can effect different data rates. The MAC module 204 may also control distributing data from flows across different component carriers or cells for carrier aggregation.

The RLC module 206 may perform segmentation of service data units (SDU) to suitably sized protocol data units (PDU). In various implementations, a data entity from/to a higher protocol layer or module is called a SDU, and the corresponding data entity to/from a lower protocol layer or module is called a PDU. The RLC module 206 may also perform retransmission management that involves monitoring sequence numbers in PDUs in order to identify missing PDUs. Additionally, the RLC module 206 may communicate status reports to enable retransmission of missing PDUs. The RLC module 206 may also be configured to identify errors due to noise or channel variations.

The package data convergence protocol module 208 may perform functions including, but not limited to, Internet Protocol (IP) header compression and decompression, ciphering and deciphering, integrity protection, retransmission management, in-sequence delivery, duplicate removal, dual connectivity, and handover functions.

The RRC module 210 may be considered one of one or more control-plane protocol responsible for connection setup, mobility, and security. The RRC module 210 may perform various functions related to RAN-related control-plane functions, including broadcast of system information; transmission of paging messages; connection management, including setting up bearers and mobility; cell selection, measurement configuration and reporting; and handling device capabilities. In various embodiments, a communication node may communicate RRC messages using signaling radio bearers (SRBs) according to protocols defined by one or more of the other modules 202-210.

Various other functions of one or more of the other modules 202-210 may be possible in any of various implementations.

Referring again to FIG. 1, within a wireless communication system 100, one purpose of a beam sweep for spatial channel sounding is to find angles of arrival (AOA) and angles of departure (AOD) of a spatial channel as early as possible so that a transmitter can address a steered wireless frame in a later transmission to a receiver with reduced pathloss than the previous transmission.

Spatial channel sounding generally involves a transmitter sending a directional signal using a transmission beam and a receiver receiving the directional signal using a reception beam. When receiving the directional signal, the receiver measures and records a signal strength of the directional signal to confirm if the AOA and AOD associated with the beam pair (the transmission beam and the reception beam) are available under a current channel environment. Channel sounding also provides that ability to measure parameters at the receiver such as path loss, delay, absorption, reflection, multipath, fading, Doppler, and/or any other parameter that affects the overall performance of the wireless communication system.

Spatial channel sounding searches do not end until all beam pairs of interest covering an entire spatial domain are verified. The amount of time to perform these spatial channel sounding searches is dependent upon a number of beam pairs reserved at the transmitter side and the receiver side. One of skill in the art will appreciate that an amount of time to perform an exhaustive spatial channel sounding search scheme increases exponentially with an increase in utilizing more steering beams at both the transmitter side and the receiver side. As a result, most wireless communication systems 100 performing exhaustive spatial channel sounding have to endure a long latency and are confronted with severe performance decay in the aspect of time and spectrum efficiency.

In implementations of the present disclosure described below, for narrow-band beam mode, rather conducting spatial channel sounding searches utilizing a single beam to conduct a beam search, multiple beams that are identifiable and separable at a receiver are utilized to conduct the beam search. Utilizing multiple beams in a beam sweep offers significant time savings and enhances a performance of a wireless communication system.

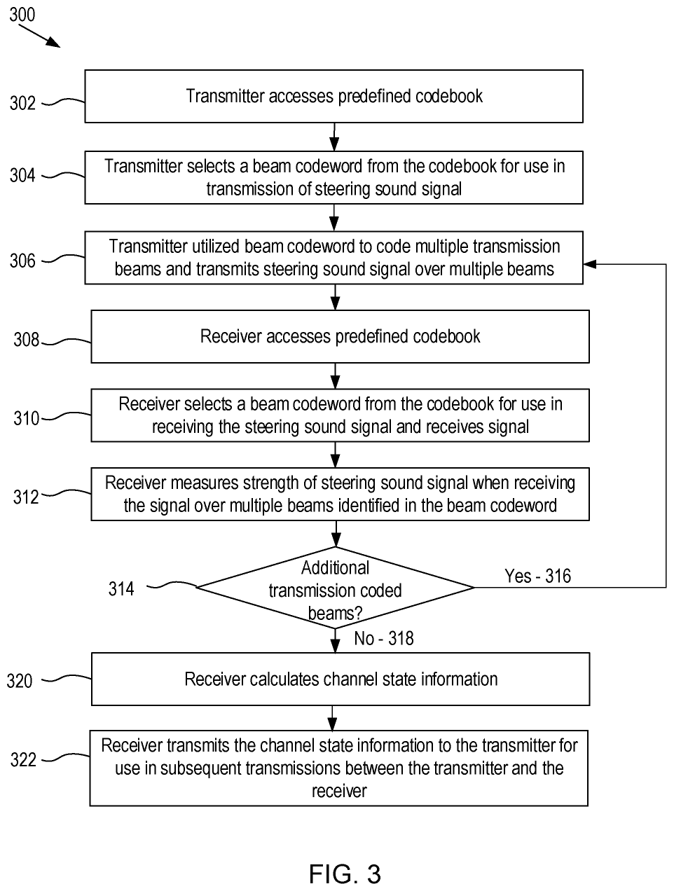

FIG. 3 is a flow chart of a method for performing a regularly coded beam sweep for spatial channel sounding. At step 302, a spatial channel sounding begins with a transmitting node of a wireless communication network (also known as a transmitter) selecting and accessing a regular codebook that is configured to utilize multiple beams on a resource unit of a resource block as part of the coded beam sweep for spatial channel sounding. The resource unit may be a unit such as time interval or a frequency bandwidth unit. The codebook is predefined in that it is constructed and available to both a transmitter and a receiving node of the wireless communication network (also known as a receiver) prior to initiation of the spatial channel sounding. However, in other implementations, the transmitter may construct a codebook at the initiation of the spatial channel sounding for that spatial channel sounding.

As known in the art, a codebook is regular and comprised of a number of beam codewords that implement channel steering vectors. While codebooks in conventional beam sweep include codewords that utilize one beam on a resource unit, implementations of the present disclosure use codewords that utilize multiple beams on a resource unit. Specifically, with a fixed frequency bandwidth unit, different codewords are utilized in different time intervals. Similarly, with a fixed time interval, different codewords can also be utilized on different frequency bandwidth units.

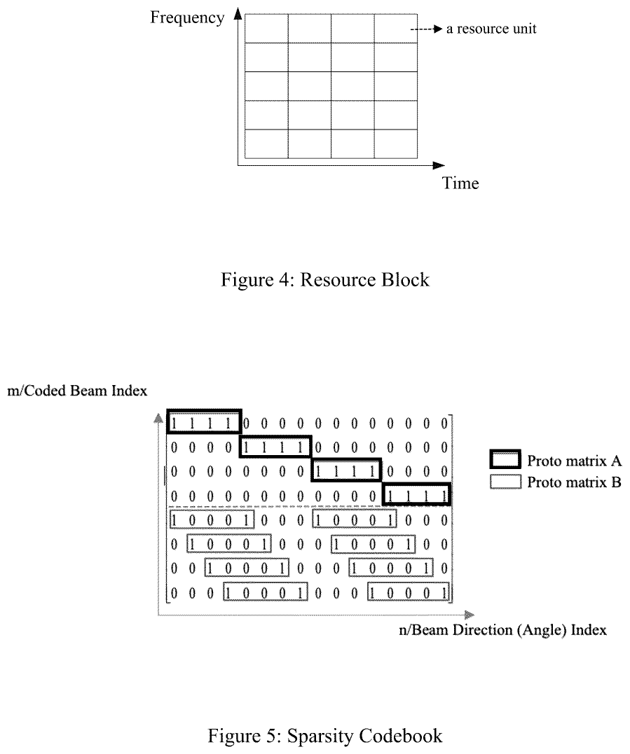

An example resource block with a plurality of resource units is illustrated in FIG. 4. Here, a resource unit refers to a unit with a period of time and a limited frequency bandwidth.

In one example, a codebook can be represented by a matrix as shown in FIG. 5 where an x-axis of the matrix is a Beam Direction (Angle) Index and a y-axis of the codebook is a Coded Beam Index. Each row of the matrix (also known as a beam codeword) represents a different coded beam where the element 1 within a row indicates a beam that is active within the coded beam. During spatial channel sounding, a transmitter utilizes each coded beam once to send a steering sound signal. A receiver may receive each steering sound signal from the transmitter using an omnidirectional beam or a coded beam, as explained in more detail below.

Referring to FIG. 5, when an entry of the codebook is equal to one, the entry represents a beam angle of a beam. The beam direction index n is mapped to the n^{th} element of a beam angle set approximately representing the whole space. In some implementations, a beam angle is calculated using the following formula when the whole space [0°, 180° ] is divided uniformly into 12 pieces:

$$\\ θ = \frac{( n - 1 ) \times 180 °}{12}$$

Examples of different implementations for constructing a codebook are discussed in more detail below in conjunction with FIGS. 5-10b.

Referring again to FIG. 3, at step 304, the transmitter selects a beam codeword in the regular codebook for use with a transmission of a steering sound signal. In some implementations, the transmitter begins with the beam codeword of the first row of the codebook and selects the beam codeword of the next row of the codebook on subsequent iterations of the coded beam sweep until each beam codeword has been used once for transmission of a steering sound signal. However, in other implementations, the transmitter may utilize other sequences to step through the beam codewords of the codebook.

At step 306, the transmitter utilizes the beam codeword to code multiple transmission beams and transmits a steering sound signal to the receiver on a resource unit of the resource block using the multiple transmission beams identified in the beam codeword. The transmitter may utilize as many transmission beams on a resource unit as possible so long as each transmission beam remains identifiable and separable at the receiver. In some implementation, the same reference signal for channel sounding may be used over different beams in each transmission.

At step 308, the receiver accesses the regular codebook that is configured to utilize multiple beams on a resource unit of a resource block as part of the coded beam sweep for spatial channel sounding. At step 310, the receiver selects a beam codeword of the regular codebook for use in receiving the steering sound signal from the transmitter using multiple reception beams, and receives the steering sound signal over the multiple reception beams identified in the beam codeword.

At step 312, the receiver measures a strength of the steering sound signal when received at the receiver over the multiple beams identified in the beam codeword. In addition to strength of the steering sound signal, the receiver may measure other parameters associated with reception of the steering sound signal at the receiver such as path loss, delay, absorption, reflection, multipath, fading, Doppler, and/or any other parameter that affects the overall performance of the wireless communication system.

The receiver may independently measure the strength of the steering sound signal at each beam that the receiver utilizes to receive the steering sound signal. For example, the receiver may measure a strength of a steering sound signal when received over a first beam identified by a beam codeword and measure a strength of a steering sound signal when received over a second beam identified by the beam codeword.

At step 314, the receiver determines whether the coded beam sweep is complete or whether there are additional beam codewords within the codebook to test as part of the beam sweep.

When the coded beam sweep is not complete and there is an additional beam codeword to test (316), the method loops to step 308 and the above-described process is repeated for the beams identified in the next beam codeword in the codebook.

Alternatively, when the coded beam swap is complete and there is not an additional beam codeword to test (318), the method proceeds to step 320 where the receiver calculates channel state information based on the information measured at step 312 for the steering sound signals.

At step 322, the receiver transmits the channel state information to the transmitter for use in subsequent transmissions between the transmitter and the receiver and for verification of beam pairs.

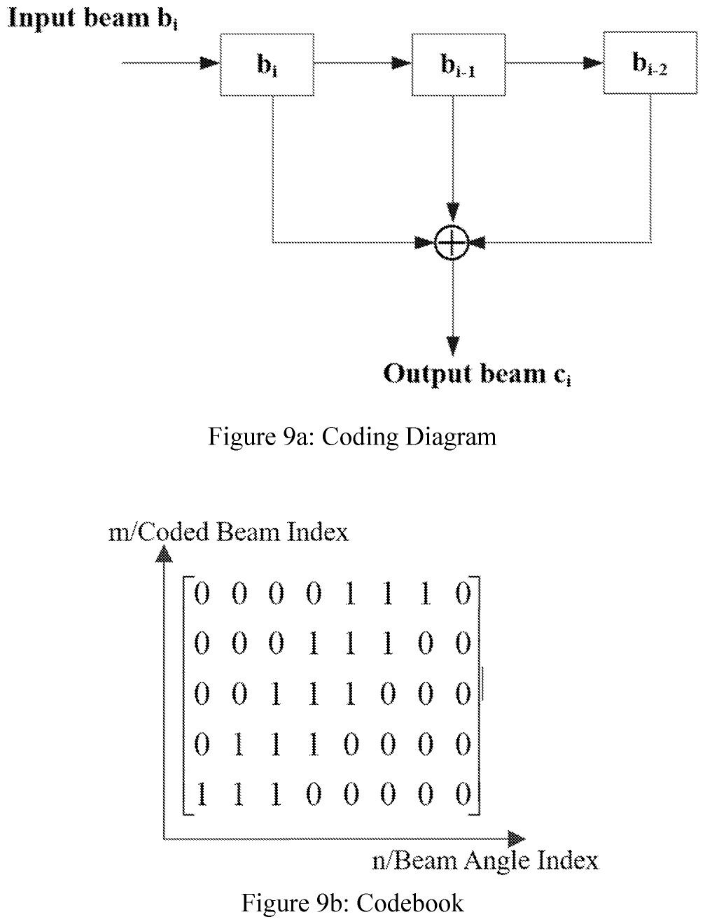

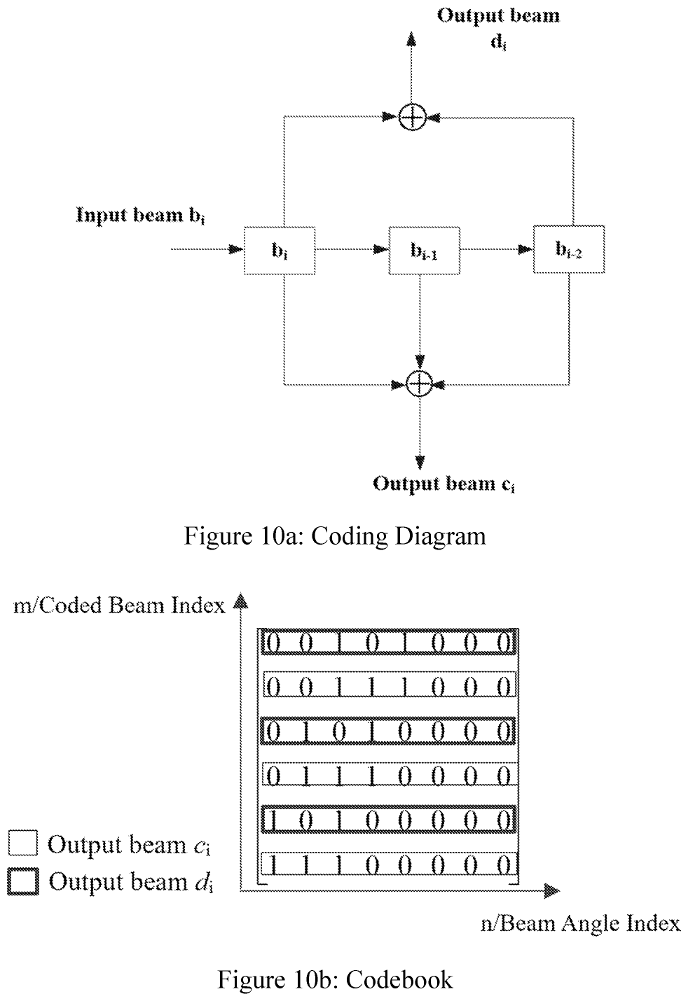

The following description describes different implementations for constructing a codebook that may be used in a regularly coded beam sweep for spatial channel sounding. An implementation for constructing a sparsity codebook is described in conjunction with FIGS. 5-8c. An implementation for constructing a convolution codebook is described in conjunction with FIGS. 9a-10b. An implementation for constructing a polarity codebook is also described below.

FIG. 5 illustrates one example of a sparsity codebook that may be used in a regularly coded beam sweep for spatial channel sounding. A sparsity codebook is characterized in that it includes a sparse linear combination of beams and can be constructed by regularly shifting Proto matrices. A Proto matrix (also known as a basic matrix) is fixed and predefined matrix.

In the example sparsity codebook (M) illustrated in FIG. 5, the x-axis of the matrix represents values along a Beam Direction (Angle) Index (variable n) and the y-axis of the matrix represents values along a Coded Beam Index (variable m). As shown in FIG. 5, a value of each entry in the sparsity codebook M(m, n) is equal to one or zero. A value of M(m, n) equal to one in a matrix entry represents that in an m^{th} coded beam, the beam direction angle has a value that may be calculated using the formula:

$$\\ θ = \frac{( n - 1 ) \times 180 °}{12} ,$$

where n is a value of the Beam Direction (Angle) Index along the x-axis of the matrix. Alternatively, a value of M(m, n) equal to zero in a matrix entry represents that a beam in the m^{th} coded beam is not active.

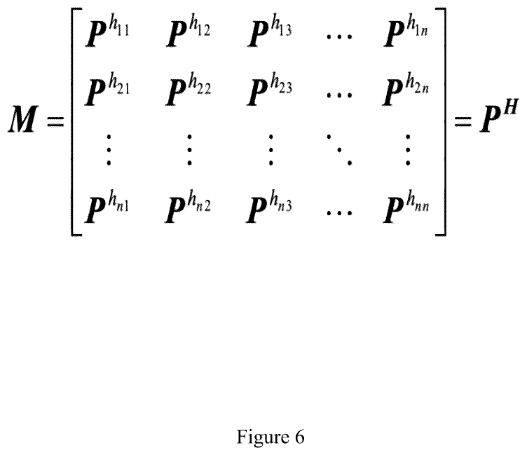

When there exists only one Proto matrix, a general symbolic expression on a regular sparse matrix can be written as shown in FIG. 6, where P is a Proto matrix (also known as a basis matrix) and h represents a number of bits/units defined for cyclic shift operation. It implies that each element in each row of P will simultaneously performs h columns cyclic shifts towards right/left. In some implementations, after shifting Proto matrix P by h=1 column, the submatrix P^{h} of codebook matrix M will be:

$$\\ {P}^{h = 1} = [ \begin{matrix}0 & 1 & 0 & 0 \\ 0 & 0 & 1 & 0 \\ 0 & 0 & 0 & 1 \\ 1 & 0 & 0 & 0\end{matrix} ]$$

where P is set to an identity matrix and different h transforms P into a different submatrix P^{h}. Furthermore, different submatrices P^{h} are comprised of a sparsity codebook matrix M as shown by FIG. 6.

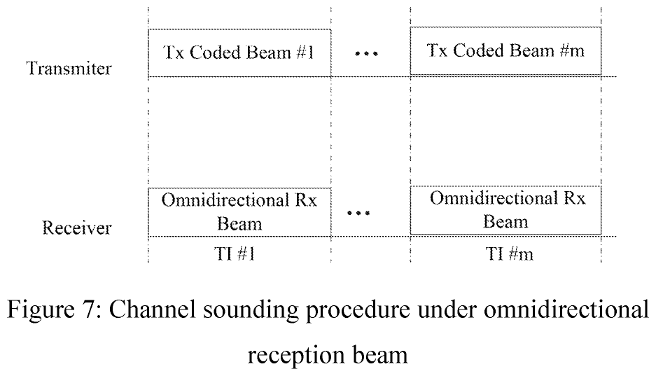

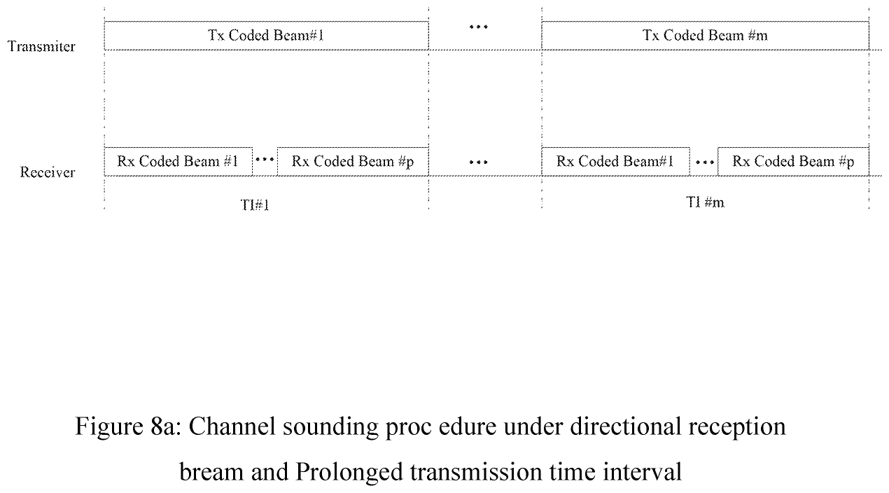

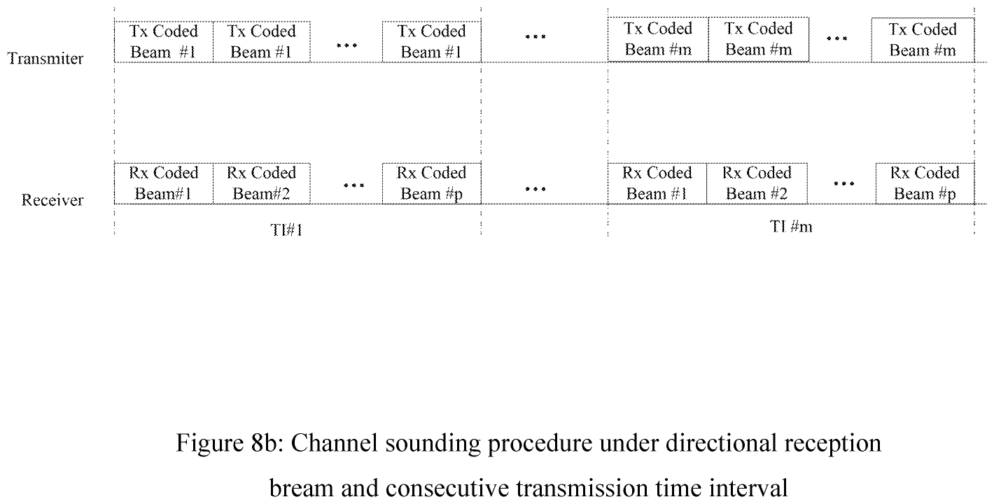

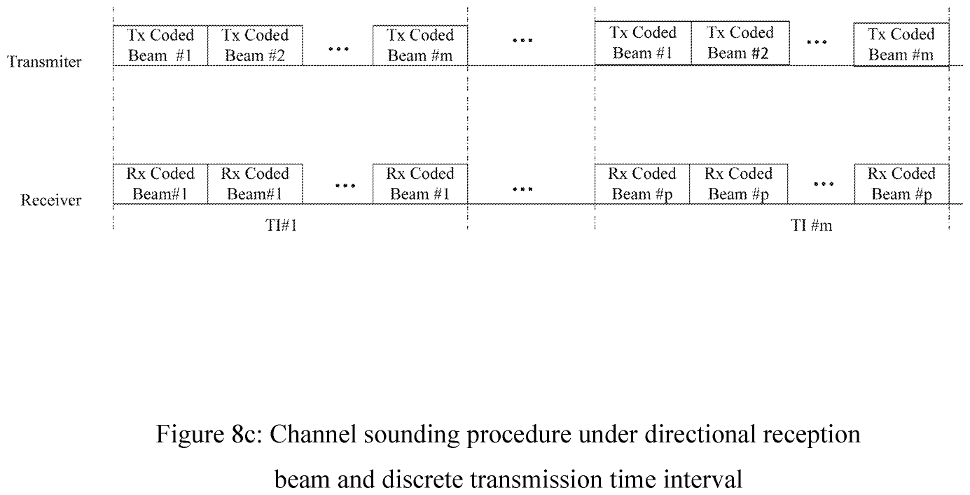

Referring again to FIG. 5, for a sparsity codebook, each row of the matrix (also known as a beam codeword) represents a different coded beam where the element 1 within a row indicates a beam that is active with the coded beam. During spatial channel sounding, a transmitter utilizes each coded beam once to transmit a steering sound signal, as described above. A receiver may utilize an omnidirectional beam or a coded beam to receive each steering sound signal transmitted from the transmitter. A difference between a receiver utilizing an omnidirectional beam (i.e only one wide-band beam) and a coded beam is that in the latter, a number of coded beams is often greater than 1 so that it will make more matchups between one specific transmission and reception coded beams than the former. Therefore, a longer time interval is required for each transmission coded beam in order to verify all possible beam parings. Timing sequences for a receiver utilizing an omnidirectional beam and for a receiving utilizing a coded beam are described below in conjunction with FIGS. 7, 8a, 8b, and 8c. One of skill in the art will appreciate that in other implementations, the time interval in the descriptions related to FIGS. 7, 8a, 8b and 8c may be replaced with a frequency bandwidth unit.

FIG. 7 illustrates a channel sounding procedure where a receiver utilizes an omnidirectional beam. As shown in FIG. 7, for each time interval a transmitter utilizes one transmission coded beam and a receiver utilizes one omnidirectional reception beam.

FIG. 8a illustrates a channel sounding procedure where a receiver utilizes a coded beam with a prolonged transmission time interval. As shown in FIG. 8a, for each time interval, a transmitter utilizes one transmission coded beam during the time interval. During the same time interval, a receiver utilizes multiple different reception coded beams.

FIG. 8b illustrates a channel sounding procedure where a receiver utilizes a coded beam with a consecutive transmission time interval. As shown in FIG. 8b, for each time interval, a transmitter consecutively utilizes the same transmission coded beam multiple times. During the same time interval, a receiver utilizes multiple different reception coded beams with each transmission by the transmitter.

FIG. 8c illustrates a channel sounding procedure where a receiver utilizes a coded beam with a discrete transmission time interval. As shown in FIG. 8c, for each time interval, a transmitter utilizes multiple different transmission coded beams. During the same time interval, the receiver consecutively utilizes the same reception coded beam multiple times.

One of skill in the art will appreciate that each of the timing sequences illustrated in FIGS. 8a, 8b, and 8c can be used to prolong a time interval for satisfying a requirement for beam pairing.

Another type of codebook for use in a regularly coded beam sweep for spatial channel sounding is a convolution codebook. Convolution can strengthen mutual connections among consecutive coded beams in a codebook. In some implementations, in convolution codebooks there are common consecutive beams active between adjacent coded beam codewords. In some other implementations, in convolution codebooks the common beams are not consecutive, but their beam indices are sufficiently near each other to strengthen mutual connections between adjacent coded beam codewords.

One example convolution type codebook can be constructed according to FIGS. 9a and 9b. FIG. 9a illustrates one form of a coding diagram and FIG. 9b is a convolution codebook associated with the coding diagram of FIG. 9a. FIG. 9a illustrates how to form a convolution codebook and FIG. 9b illustrates the corresponding codebook. Beam bᵢ represents the bᵢ^{th} beam of a beam set. In FIG. 9a, subscript ‘-’ represents a previous input beam of the beam set. Another example convolution type codebook can be constructed according to FIGS. 10a and 10b. FIG. 10a illustrates another form of a coding diagram and FIG. 10b is a convolution codebook associated with the coding diagram of FIG. 10a.

In coding diagrams such as those illustrated in FIGS. 9a and 9b, binary beam bᵢ implies whether or not a corresponding AOA/AOD exists. For example, in some implementations, when bᵢ is equal to one, it indicates that AOA/AOD exists. Alternatively, if bᵢ is not equal to one, it indicates that AOA/AOD does not exist. When more output beams are generated in parallel, a convolution codebook M will encompass coded beams from different output ports as illustrated in FIGS. 9a and 9b.

A coded beam generated in a convolutional way can be generally written as:

cᵢ=bᵢ⊕ . . . ⊕bᵢ₋ₖ₊₁,

where k denotes a number of memory units symbolized by blocks of a coding diagram and optionally, only a part of the memory units is incorporated into the coded beam cᵢ, as output dᵢ does in FIG. 10b.

Yet another type of codebook for use in a regularly coded beam sweep for spatial channel sounding is a polarity codebook. If employing a polarity property, a codebook (matrix M) can be signified by:

M=F⊗F . . . ⊗F=F^{⊗z},

where F is a kernel matrix, ⊗ is a Kronecker product operator, and z denotes a number of the kernel matrix. When z=2 and

$$\\ F = [ \begin{matrix}1 & 0 \\ 1 & 1\end{matrix} ] ,$$

a codebook matrix M may be written as:

$$\\ M = [ \begin{matrix}1 & 0 \\ 1 & 1\end{matrix} ] ⊗ [ \begin{matrix}1 & 0 \\ 1 & 1\end{matrix} ] = [ \begin{matrix}1 & 0 & 0 & 0 \\ 1 & 1 & 0 & 0 \\ 1 & 0 & 1 & 0 \\ 1 & 1 & 1 & 1\end{matrix} ]$$

In cases where z≠2ⁱ (i is a positive integer), two options may be considered for generating a codebook M. A first option is to tailor a higher dimensional matrix M′=F^{⊗2}^{ⁱ}. A second option is to perform matrix fusion under the framework C, where:

$$\\ {C}_{p + q , p + q} = [ \begin{matrix}{A}_{p \times p} & {O}_{p \times q} \\ \begin{matrix}{B}_{q \times q} & {O}_{q \times ( p - q )}\end{matrix} & {B}_{q \times q}\end{matrix} ] .$$

For example, assuming that z, p and q are individually equal to 7, 3 and 4, matrix M will be determined by:

$$\\ {M}_{7} = [ \begin{matrix}{A}_{4 \times 4} & {O}_{4 \times 4} \\ \begin{matrix}{B}_{3 \times 3} & {O}_{3 \times 1}\end{matrix} & {B}_{3 \times 3}\end{matrix} ] , where {A}_{4 \times 4} = {F}^{{⊗}_{2}} ,$$

$$\\ {B}_{3 \times 3} = [ \begin{matrix}{F}^{{⊗}_{1}} & {O}_{2 \times 2} \\ \begin{matrix}{F}^{{⊗}_{0}} & {O}_{1 \times ( 2 - 1 )}\end{matrix} & {F}^{{⊗}_{0}}\end{matrix} ] ( {F}^{{⊗}_{0}} = 1 ) .$$

In implementations of the present disclosure described above, for narrow-band beam mode, rather conducting spatial channel sounding searches utilizing a single beam to conduct a beam search, multiple beams that are identifiable and separable at a receiver are utilized to conduct the beam search. In performing the spatial channel sounding with multiple beams, codebooks are utilized such as specialized sparsity codebooks, convolution codebooks, and polarity codebooks. Utilizing multiple beams in a beam sweep offers significant time savings and enhances a performance of a wireless communication system.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
accessing, at a transmitter, a regular codebook configured to utilize multiple beams on a resource unit as part of a coded beam sweep for spatial channel sounding;
transmitting, from the transmitter to a receiver, a steering sound signal utilizing a beam codeword of the regular codebook that identifies multiple beams for transmission on the resource unit; and
receiving, at the transmitter, channel state information from the receiver, the channel state information being determined at the receiver based on a strength of the steering sound signal when received at the receiver over the multiple beams identified in the beam codeword.

2. The method of claim 1, wherein the regular codebook is a sparsity codebook.

3. The method of claim 1, wherein the regular codebook is a convolution codebook.

4. The method of claim 1, wherein the regular codebook is a polarity codebook.

5. The method of claim 1, further comprising:
transmitting, from the transmitter to a receiver, a second steering sound signal on a second resource unit utilizing a second beam codeword of the regular codebook that identifies multiple beams for transmission on the second resource unit;
wherein the channel state information received from the receiver is additionally based on a strength of the second steering sound signal when received at the receiver over the multiple beams identified in the second beam codeword.

6. The method of claim 1, wherein the resource unit is a time interval.

7. The method of claim 1, wherein the resource unit is a frequency bandwidth unit.

8. The method of claim 1, further comprising:
verifying, at the transmitter, at least one beam pair comprising a transmission beam and a reception beam based on the received channel state information.

9. A wireless communication apparatus comprising:
a memory operable to store computer-readable instructions; and
a processor circuitry operable to read the computer-readable instructions, the processor circuitry when executing the computer-readable instructions is configured to:
access a regular codebook configured to utilize multiple beams on a resource unit as part of a coded beam sweep for spatial channel sounding;
transmit, to a receiver, a steering sound signal utilizing a beam codeword of the regular codebook that identifies multiple beams for transmission on the resource unit; and
receive channel state information from the receiver, the channel state information being determined at the receiver based on a strength of the steering sound signal when received at the receiver over the multiple beams identified in the beam codeword.

10. A method for wireless communication, comprising:
accessing, at a receiver, a regular codebook configured to utilize multiple beams on a resource unit as part of a coded beam sweep for spatial channel sounding;
receiving, at the receiver, a steering sound signal that was transmitted utilizing a beam codeword of the regular codebook that identifies multiple beams for transmission on the resource unit;
measuring, at the receiver, a strength of the steering sound signal when received over the multiple beams identified in the beam codeword;
calculating channel state information, at the receiver, based on the measured strength of the steering sound signal; and
transmitting the channel state information from the receiver to the transmitter.

11. The method of claim 10, wherein the resource unit is a time interval.

12. The method of claim 10, wherein the resource unit is a frequency bandwidth unit.

13. The method of claim 10, wherein the regular codebook is a sparsity codebook.

14. The method of claim 10, wherein the regular codebook is a convolution codebook.

15. The method of claim 10, wherein the regular codebook is a polarity codebook.

16. The method of claim 10, further comprising:
receiving, at the receiver, a second steering sound signal that was transmitted on a second resource unit utilizing a second beam codeword of the regular codebook that identifies multiple beams for transmission on the second resource unit; and
measuring, at the receiver, a strength of the second steering sound signal when received over the multiple beams identified in the second beam codeword;
wherein the channel state information is calculated additionally based on the strength of the second steering sound signal.

17. (canceled)

18. (canceled)
